(19) United States
(12) Patent Application Publication
(10) Pub. No.: US 2010/0177006 A1
(43) Pub. Date: Jul. 15, 2010

(54) ANTENNA

(75) Inventors: Chien-Hung Lin, Taipei Hsien (TW); Hung-Jen Chen, Taipei Hsien (TW); Yu-Yuan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: Cheng Uei Precision Industry Co., Ltd., Taipei Hsien (TW)

(21) Appl. No.: 12/354,729

(22) Filed: Jan. 15, 2009

(51) Int. Cl. H01Q 1/36; H01Q 1/50; H01Q 1/48

(52) U.S. Cl. 343/845; 343/895; 343/860

(57) ABSTRACT

An antenna connected with a matching circuit is mounted in a portable electronic device for receiving radio frequency band. The antenna includes a flat-plate coil with a shape thereof depending on a receiving space of the portable electronic device, a feeding portion defined at one free end of the coil for connecting with the matching circuit, and a grounding portion defined at the other free end of the coil. Accordingly, the antenna can be received in the portable electronic device with a small-occupied space, and is convenient for a user to listen to broadcast at random.

### BACKGROUND OF THE INVENTION

1. Field of the Invention

This present invention relates to an antenna, and more specifically to an antenna adapted for receiving radio frequency band.

2. The Related Art

With the increasing development of the electronic technology, more and more portable electronic devices are equipped with a function of receiving broadcast. Consequently, an antenna for receiving radio frequency transmission in the AM radio frequency bands is necessary or desirable. The antenna presently disclosed for receiving broadcast signal, in general, in medium wave ranging from 500 KHz to 1700 KHz, is usually a long wire and mounted in an earphone line for reducing occupied space of the portable electronic device. However, such design is not convenient for use, because a user has to tote an earphone and plug the earphone into the portable electronic device for listening to the broadcast.

### SUMMARY OF THE INVENTION

An object of the invention is to provide an antenna which occupies a small space in a portable electronic device and is convenient for use. The antenna connected with a matching circuit is mounted in the portable electronic device in order to receive radio frequency band. The antenna includes a flat-plate coil with a shape thereof depending on a receiving space of the portable electronic device, a feeding portion defined at one free end of the coil for connecting with the matching circuit, and a grounding portion defined at the other free end of the coil.

Another object of the invention is to provide an antenna connected with a matching circuit mounted in a portable electronic device for receiving radio frequency band. The antenna includes a plurality of superposed flat-plate coils spaced apart from one another and connected in series. The coils, with shapes thereof depending on a receiving space of the portable electronic device, have magnetic fields with the same direction. A feeding portion is defined at one free end of the series of the coils for connecting with the matching circuit, and a grounding portion is defined at the other free end of the series of the coils.

As described above, the antenna mounted in the portable electronic device has at least one flat-plate coil which is shaped according to the receiving space of the portable electronic device. Accordingly, the antenna can be received in the portable electronic device with a small-occupied space, and is convenient for a user to listen to broadcast without carrying an antenna-embedded earphone.

### BRIEF DESCRIPTION OF THE DRAWINGS

The invention, together with its objects and the advantages thereof may be best understood by reference to the following description taken in conjunction with the accompanying drawings, in which:

FIG. 1 shows a structure of an antenna in accordance with a first embodiment of the present invention;

FIG. 2 shows a structure of an antenna in accordance with a second embodiment of the present invention;

FIG. 3 shows a received signal strength indicator (RSSI) test chart of the antenna shown in FIG. 1, wherein an earphone antenna in prior art and a compared coil are tested and illustrated;

FIG. 4 shows a signal-to-noise (S/N) ratio test chart of the antenna shown in FIG. 1, wherein the earphone antenna and the compared coil are tested and illustrated; and

FIG. 5 is a diagram showing values of the RSSI and S/N resulting from the antenna of FIG. 1, the earphone antenna and the compared coil.

### DETAILED DESCRIPTION OF THE EMBODIMENTS

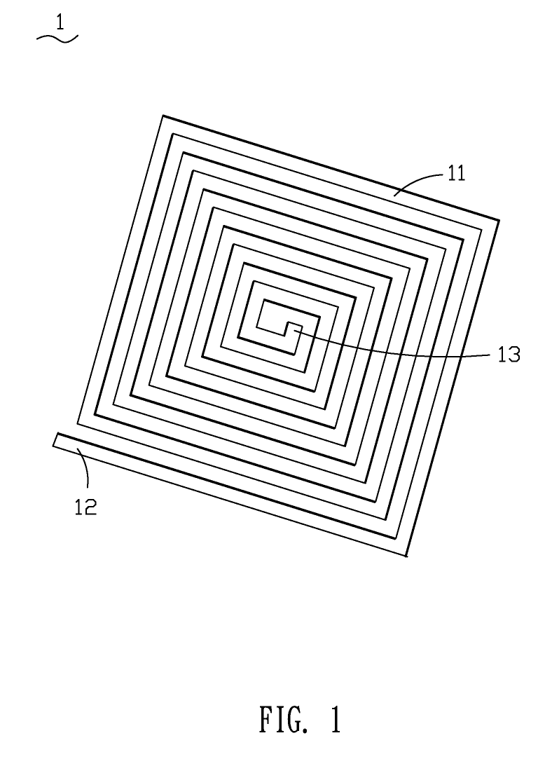

With Reference to FIG. 1, an antenna 1 of a first embodiment according to the present invention mounted in a portable electronic device (not shown) for receiving amplitude modulation (AM) radio signal is shown. The antenna 1 connected with a matching circuit (not shown) has a coil 11 of flat-board shape. The coil 11 may be formed by a metal wire wound repetitionarily, with a shape thereof depending on a receiving space of the portable electronic device. In this embodiment, the coil 11 is substantially rectangular. One end of the metal wire is defined a feeding portion 12 at a periphery of the coil 11 for connecting with the matching circuit, while the other end of the metal wire is defined a grounding portion 13 at a center of the coil 11 for being grounded.

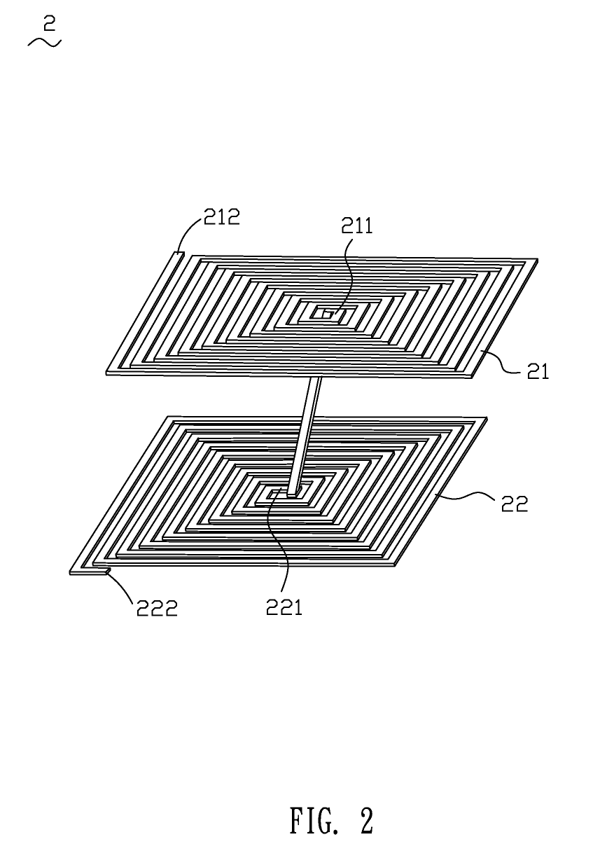

Please refer to FIG. 2, an antenna 2 of a second embodiment according to the present invention is shown. The antenna 2 connected with a matching circuit (not shown, formed corresponding to the antenna 2) includes two coils, of which construction is somewhat analogous to that of the coil 11 in the first embodiment. The coils, which are made of a metal wire encircled repetitionarily, in this case, are defined an upper coil 21 and a lower coil 22 underlying the upper coil 21. The upper coil 21 is wound along an anti-clockwise direction and defines a center end 211 and a periphery end 212. The lower coil 22 is wound along a clockwise direction and defines a center end 221 and a periphery end 222. As a result, a portion of the metal wire between the upper coil 21 and the lower coil 22 is connected with the center ends 211, 221. The periphery end 212 of the upper coil 21 is used as a feeding portion 212 of the antenna 2 for connecting with the matching circuit, while the periphery end 222 of the lower coil 22 is used as a grounding portion 222 of the antenna 2. Thus, when a current is fed from the feeding portion 212 and flows through the coils 21, 22, the upper coil 21 generates a magnetic field pointing upwards, and the lower coil 22 also generates a magnetic field pointing upwards, superimposing upon the magnetic field caused by the upper coil 21 for enhancing the strength of the magnetic field.

It should be noted that the number of the coils constituting the antenna could be changed for conforming different demands and should not be limited. Moreover, the two adjacent coils are wound in an opposite direction in the case that the center ends or the periphery ends of the coils should be connected together for obtaining magnetic fields with the same direction. In this case, if the number of the coils is even number, the feeding portion and the grounding portion of the antenna are the two periphery ends of the coils, disposed at an exterior of the coils, which is convenient to connect the antenna with other circuits. Thereinto, when the number of the coils ranges from four to six, the antenna can gain a preferable effect for receiving AM radio signal without matching circuit.

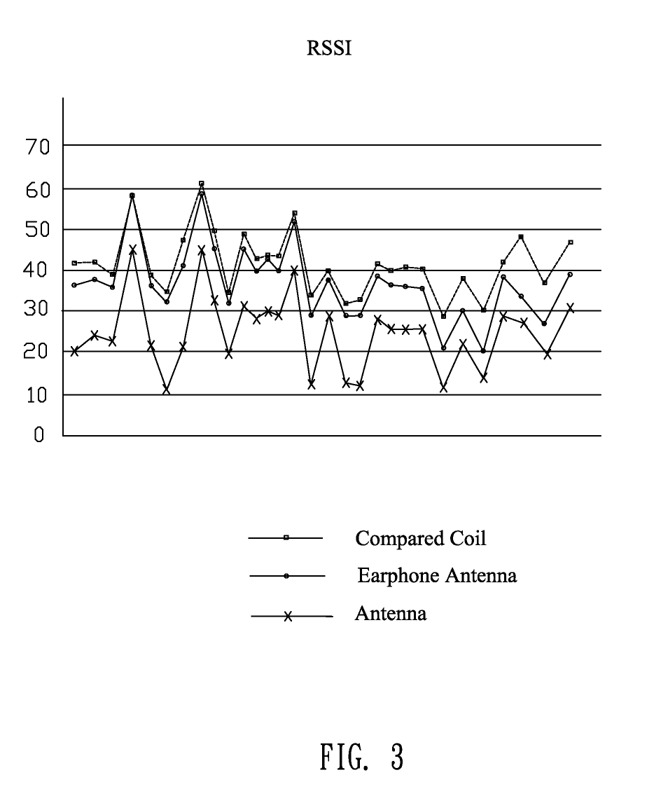

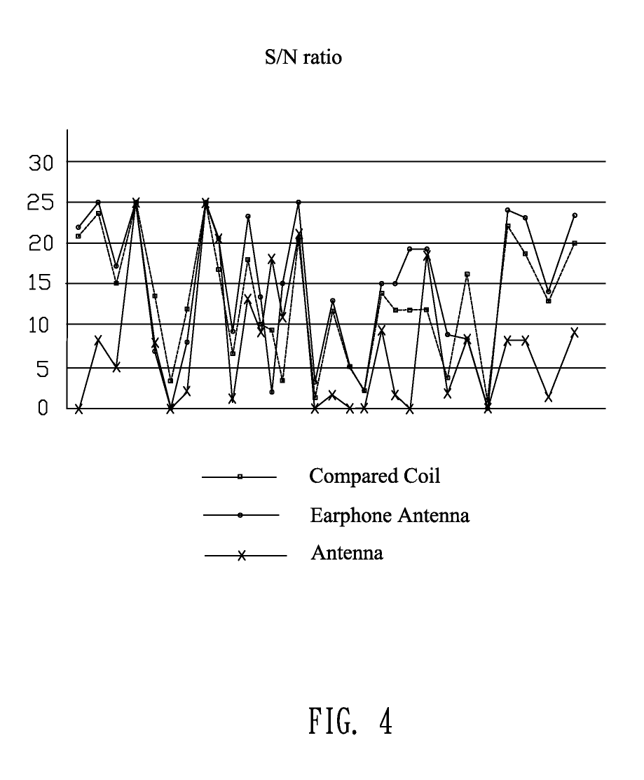

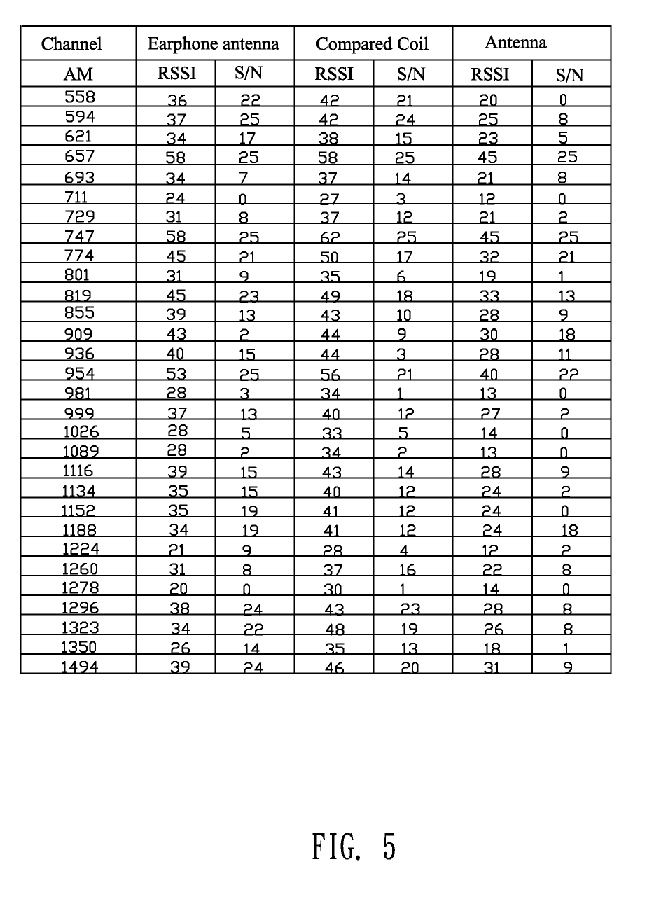

FIG. 3 is a view showing received signal strength indicator (RSSI) test chart of the antenna 1 in the first embodiment on different channels, where an earphone antenna (not shown) in prior art and a compared coil (herein, the compared coil is formed with a wire wound on a rob repetitionarily and randomly, not shown) are tested and illustrated for comparing with the antenna 1. FIG. 4 is a view showing signal-to-noise (S/N) ratio test chart of the antenna 1 in the first embodiment on different channels, where the earphone antenna and the compared coil are tested and illustrated for comparing with the antenna 1. FIG. 5 is a diagram showing values of RSSI and S/N ratio of the antenna 1, the earphone antenna and the compared coil on different channels. Thereinto, when the antenna 1 is operated on channel 657, the RSSI value and the S/N value of the antenna 1 are respectively 45 and 25. When the antenna 1 is operated on channel 774, the RSSI value and the S/N value of the antenna 1 are respectively 32 and 21. And when the antenna 1 is operated on channel 909, the RSSI value and the S/N value of the antenna 1 are respectively 30 and 18. As seen from above, the antenna 1 has a good performance for receiving signal.

As described above, the antenna mounted in the portable electronic device is made up of at least one flat-plate coil and is shaped according to the receiving space of the portable electronic device. Accordingly, the antenna can be received in the portable electronic device with a small-occupied space, and is convenient for a user to listen to broadcast without carrying an antenna-embedded earphone.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An antenna connected with a matching circuit mounted in a portable electronic device for receiving radio frequency band, comprising:
a flat-plate coil with a shape thereof depending on a receiving space of the portable electronic device;
a feeding portion defined at one free end of the coil for connecting with the matching circuit; and
a grounding portion defined at the other free end of the coil.

2. The antenna as claimed in claim 1, wherein the coil is substantially rectangular.

3. The antenna as claimed in claim 1, wherein the coil is formed by a metal wire wound repetitionarily.

4. An antenna connected with a matching circuit mounted in a portable electronic device for receiving radio frequency band, comprising:
a plurality of superposed flat-plate coils spaced apart from one another and connected in series, the coils, with shapes thereof depending on a receiving space of the portable electronic device, having magnetic fields with the same direction;
a feeding portion defined at one free end of the series of the coils for connecting with the matching circuit; and
a grounding portion defined at the other free end of the series of the coils.

5. The antenna as claimed in claim 4, wherein each of the coils has a center end and a periphery end, the two adjacent coils are twisted in an opposite direction, with the two center ends or the two periphery ends thereof connected, for forming magnetic fields with the same direction.

6. The antenna as claimed in claim 5, wherein the number of the coils is even number for disposing the feeding portion and the grounding portion at an exterior of the coils for convenient assembly.
